(19) United States
(12) Patent Application Publication
(10) Pub. No.: US 2023/0329154 A1
(43) Pub. Date: Oct. 19, 2023

(54) ELECTROCHEMICAL PLANT TREATMENT APPARATUS AND METHOD

(71) Applicants: Mehrooz ZAMANZADEH, Pittsburgh,, PA (US); Carolyn TOME, Pittsburgh, PA (US); MATERGENICS, INC, Pittsburgh, PA (US)

(72) Inventors: Mehrooz Zamanzadeh, Pittsburgh, PA (US); Carolyn Tome, Pittsburgh, PA (US)

(73) Assignee: MATERGENICS, INC, Pittsburgh, PA (US)

(21) Appl. No.: 18/027,152

(22) PCT Filed: Sep. 21, 2021
(86) PCT No.: PCT/US2021/051036

§ 371 Date: Mar. 20, 2023

Related U.S. Application Data
(60) Provisional application No. 63/081,306, filed on Sep. 21, 2020.
(60) Provisional application No. 63/081,298, filed on Sep. 21, 2020.

(51) Int. Cl. A01G 7/04

(52) U.S. Cl. CPC A01G 7/04

(57) ABSTRACT

An electrochemical cell has an active alloy anode including an active alloy and a passive alloy cathode including a passive alloy with the active alloy having a higher reduction potential than the passive alloy within growth media. The active alloy anode and the passive alloy cathode are positioned to drive a plurality of transport ions into a plant in some embodiments to enhance plant growth and to kill weeds in other embodiments.

### CROSS REFERENCE TO RELATED APPLICATIONS

This application claims the benefit under 35 U.S.C. §119(e) of co-pending U.S. Provisional Application No. 63/081,298 entitled “ELECTROCHEMICAL PLANT TREATMENT APPARATUS AND METHOD” filed Sep. 21, 2020 and of co-pending U.S. Provisional Application No. 63/081,306 entitled “ELECTROCHEMICAL WEED TREATMENT APPARATUS AND METHOD” filed Sep. 21, 2020. Both applications are incorporated herein by reference.

### TECHNICAL FIELD

The subject disclosure is directed to systems, methods, and apparatus for enhancing the growth of plants through the electrochemical treatment of growth media.

### BACKGROUND ART

Plants include many types of polymers and polymer networks. Changes in polymer network structure as a result of electrical field application are well known. High-intensity electrical field pulses and their effects on dehydration characteristics and rehydration properties of potato cubes and other vegetables are known. Such applications have been shown to have potential benefits over thermal and chemical unit operations in food processing.

Many methods of applying electricity to plants and/or food products exist, such as ohmic heating, microwave heating, low electrical field stimulation, high-voltage arc discharge, low-voltage alternating current and high-intensity pulsed electric fields. However, the effect of such techniques on soils is less understood.

Soils are mixtures of minerals, organic matter, air and water. The organic matter consists of residues from plants, animals and other living organisms. Soil has various physical properties, including color, soil structure, and texture, and chemical properties, such as pH, cation exchange capacity, anion retention, and other related properties. Soil structure refers to the arrangement of soil particles into aggregates.

Soil pH affects the availability of nutrients to plants. Calcium and magnesium become more available to plants in acidic soils, but micronutrients, such as iron, aluminum and manganese become soluble and can reach levels toxic to plants. These micronutrients can react with phosphorus to form compounds that are insoluble and not available to plants. In highly acidic soils, phosphorus precipitates with higher levels of calcium in the soil to become less available to plants. Conversely, several soil micronutrients, including zinc, copper and cobalt, become less available to plants in alkaline soils.

Additionally, soil pH can affect the population and activity of microorganisms. The activity of nitrogen-fixing bacteria associated with legumes is impaired in acid soils, resulting in less nitrogen fixation. Further, the movement of ions can play various roles in changing the physical properties and chemical properties of soils, as they relate to favorable or to unfavorable conditions for agriculture. Accordingly, there is a need to enhance the beneficial effects of various types of soil treatments in agricultural applications.

Moreover, uncontrolled weeds in crop fields can use nutrients and water needed by crop plants, can shade or choke crop plants, can contaminate crop products with noxious or otherwise undesirable weed seed or other parts of weed plants, and can damage harvesting equipment. Weeds in residential lawns and in recreational and commercial areas such as parks, golf courses, and playgrounds are generally unsightly and detract from appearance in addition to interfering with desired plants and activities.

Some weeds in pastures can be toxic to livestock or create other undesirable problems, such as cockleburs or briars. Some weeds also release chemicals into soil that interfere with germination or growth of desired seeds. Seeds of weed plants can be introduced into a field or other region via droppings of birds or other animals or via wind or water in addition to being released from weed plants already growing in the field. Some weed seed can also enter via a crop seed mixture.

Numerous strategies, equipment, and chemicals for dealing with weeds have been developed over the years. The use of herbicides is probably the most widespread strategy. Generally, pre-plant and pre-emergent herbicides can be broadcast over fields without injury to crop plants. Nevertheless, the use of herbicides can introduce undesirable, if not dangerous, chemicals and chemical residues into the environment. Moreover, the use of herbicides is prohibited or restricted in organic farming applications.

Other manual and mechanically-aided methods of weed control can be deployed. Depending on the planted crop, a weed control in the immediate vicinity of the crop is required. These methods, generally, are deployed at an early growth state. At this point, crop plants as well as weeds are still very small and in close proximity to one another. In order to avoid damage to the crop plant, it is useful to employ selective methods. Unfortunately, these manual and mechanically-aided methods of weed control are very labor-intensive, so that there is a need for an improved method for controlling weeds.

### DISCLOSURE OF INVENTION

In various implementations, an electrochemical treatment system for enhancing the growth of a plant or for controlling the growth of a weed within growth media is provided. The growth media includes an aqueous solution having a plurality of transport ions therein. An electrochemical cell has an active alloy anode including an active alloy and a passive alloy cathode including a passive alloy with the active alloy having a higher reduction potential than the passive alloy within the growth media. The active alloy anode and the passive alloy cathode are submerged in the growth media at least partially and are positioned at a sufficient distance to create a potential difference therebetween with the region adjacent to the passive alloy cathode being defined as a cathode region. In some embodiments, plant is positioned within the cathode region and the potential difference is driving the plurality of transport ions to the plant. In other embodiments, a weed is positioned within the anode region and the potential difference is driving the plurality of transport ions to the passive alloy cathode.

### BRIEF DESCRIPTION OF THE DRAWINGS

FIG. 1 is a schematic diagram of a garden in accordance with the disclosed subject matter.

FIG. 2 is a schematic diagram of another embodiment of a garden in accordance with the disclosed subject matter.

FIG. 3 is a schematic diagram of another embodiment of a garden in accordance with the disclosed subject matter.

FIG. 4 is a schematic diagram of a fragmentary view in cross section of a group of weeds in accordance with the disclosed subject matter.

FIG. 5 is a schematic diagram of another embodiment of a garden in accordance with the disclosed subject matter.

FIG. 6 is an exemplary process in accordance with the disclosed subject matter.

FIG. 7 is another exemplary process in accordance with the disclosed subject matter.

### MODES FOR CARRYING OUT THE INVENTION

The subject disclosure is directed to systems, methods, and apparatus for enhancing the growth of plants through the electrochemical treatment of growth media. More specifically, the subject disclosure is directed to the establishment of an electrochemical cell through the insertion of an active alloy anode and a passive alloy cathode into soils and other growth media to enhance the growth of plants that are in proximity of the cathode.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In some embodiments, enhanced growth of plants has been observed in a region that surrounds a cathode within an electrochemical cell that has been formed in growth media. The growth media includes an electrolyte solution that includes a plurality of transport ions that are essential for plant growth. Additionally, the electrochemical cell can be utilized to manipulate the pH of the growth media that is in proximity to the cathode. In some embodiments, the electrochemical cell can increase the concentration of water in the cathode region to further enhance plant growth.

The electrochemical cell can be formed from an active alloy anode and a passive alloy cathode. The active alloy has a higher reduction potential than the passive alloy within the growth media, so that a potential difference is formed when the electrodes are submerged in the growth media. Plants that are positioned in proximity to the cathode experience enhanced growth due to the plurality of transport ions that are driven to the cathode.

In other embodiments, the ability to control the localized environment around an anode to inhibit and/or to kill weeds in growth media has been observed in a region. The growth media includes an electrolyte solution that provides for the movement of ions that can be controlled with an electrochemical cell. The electrochemical cell can be utilized to manipulate the pH of the growth media that is in proximity to the anode to increase the acidity, which can inhibit the growth of weeds and/or kill the weeds. In some embodiments, the electrochemical cell can remove moisture from the region that surrounds the anode to provide an alternative mechanism for killing weeds.

The electrochemical cell can be formed from an active alloy anode and a passive alloy cathode. The active alloy has a higher reduction potential than the passive alloy within the growth media, so that a potential difference is formed when the electrodes are submerged in the growth media. The potential difference can be enhanced through the use of an external power supply. The effect can be further enhanced through the use of a mesh near the anode.

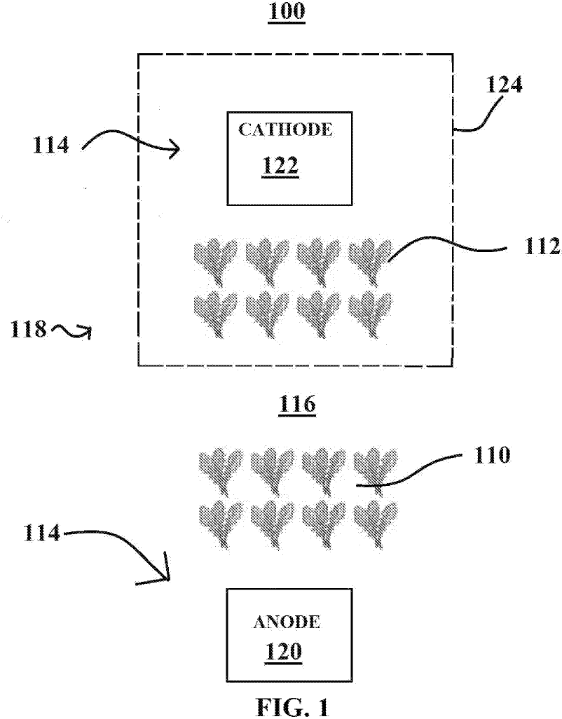

Referring now to FIG. 1, there is shown a garden, generally designated by the numeral 100, which has a plurality of plants that are separated into two groups 110-112 therein. The garden 100 includes an electrochemical treatment system 114 that is particularly adapted to treat growth media 116 that is positioned within the garden 100.

The system 114 is particularly adapted to enhance the growth of plant group 112 through the treatment of the growth media 116. In this particular embodiment, the growth media 116 includes soil. The system 114 can be provided in an assembled form or as a kit for assembly.

The dimensions and structure of the garden 100 is not critical. Additionally, the term “garden” shall be given its most expansive understanding to include various types of fields, nurseries, orchards, greenhouses, and/or other places in which natural or cultivated plants are grown. Further, the growth media 116 can include soil, clays, or liquid media, such as a hydroponic growth medium.

The plants with the plant groups 110-112 can include plants that produce fruits, vegetables, medicinal plant products, crops, and/or other useful plant products. In this exemplary embodiment, the plant groups 110-112 include cucumber plants. In other embodiments, the plant groups 110-112 can include avocado plants.

As shown in FIG. 1, the system 114 is essentially an electrochemical cell 118 having an active alloy anode 120 and a passive alloy cathode 122. The terms “active alloy” and “passive alloy” should be understood in relation to one another, such that the active alloy is higher on a galvanic series for a given growth media than the passive alloy. The relationship of the active alloy to the passive alloy on the galvanic series can create a potential difference between the active alloy anode 120 and the passive alloy cathode 122 when the electrodes are placed, at least partially, in the growth media 116.

The immersion or submersion of the active alloy anode 120 and the passive alloy cathode 122, at least partially, creates the electrochemical cell 118 because the growth media 116 includes an aqueous solution that includes transport ions. The transport ions can be attracted to the passive alloy cathode 122, so that the growth of the plant group 112 can be enhanced within a cathode region 124.

The cathode region 124 is an area/volume that is in proximity of the passive alloy cathode 122. In some embodiments, the cathode region 124 is in close proximity to the passive alloy cathode 122.

The active alloy anode 120 can include zinc and zinc alloys, magnesium and magnesium alloys, and aluminum and aluminum alloys. Magnesium alloys can include cast alloys, wrought alloys, and magnesium-aluminum alloys. Aluminum alloys can include cast alloys, wrought alloys, and aluminum-magnesium alloys. In this exemplary embodiment, the active alloy anode 120 can include a magnesium alloy.

The passive alloy cathode 122 can include titanium and titanium alloys, iron and iron alloys, and steel alloys and stainless steel alloys. Titanium alloys can include alpha alloys, near-alpha alloys, beta alloys, near-beta alloys, and alpha and beta alloys. Iron alloys, steel alloys, and stainless steel alloys include cast irons, gray irons, white irons, ductile irons, malleable irons, wrought iron, steels, crucible steels, carbon steels, spring steels, alloy steels, maraging steels, stainless steels, weathering steels, tool steels, and other specialty steels. In this exemplary embodiment, the passive alloy cathode 122 is made from steel or stainless steel, so that the potential difference between the active alloy anode 120 and the passive alloy cathode 122 is about -1.15 V.

The aqueous component of the growth media 116 can be any suitable aqueous solution. The aqueous solution can be an alkaline solution, an acid solution, or another water-based solution. Other suitable aqueous solutions can include potable water and low conductivity water.

The transport ions can include ammonium ions, phosphorous ions, potassium ions, calcium ions, magnesium ions, boron ions, copper ions, iron ions, manganese ions, molybdenum ions, nickel ions, and/or zinc ions. In other embodiments, the transport ions can include protons and/or polarized water molecules.

The geometric configuration of the electrochemical cell is not critical. The active alloy anode 120 and the passive alloy cathode 122 can have any suitable geometric configuration. The active alloy anode 120 and the passive alloy cathode 122 can be in the form of wire, mesh, foil, an ingot, sheet or wire.

The system 114 can be provided in an assembled form or as a kit for assembly to farmers, gardeners, and other people with interest in either home agriculture or industrial agriculture. The kits can be particularly adapted to third world environments, where external power is not readily available. As a result, the kits can provide an inexpensive means for improving plant growth.

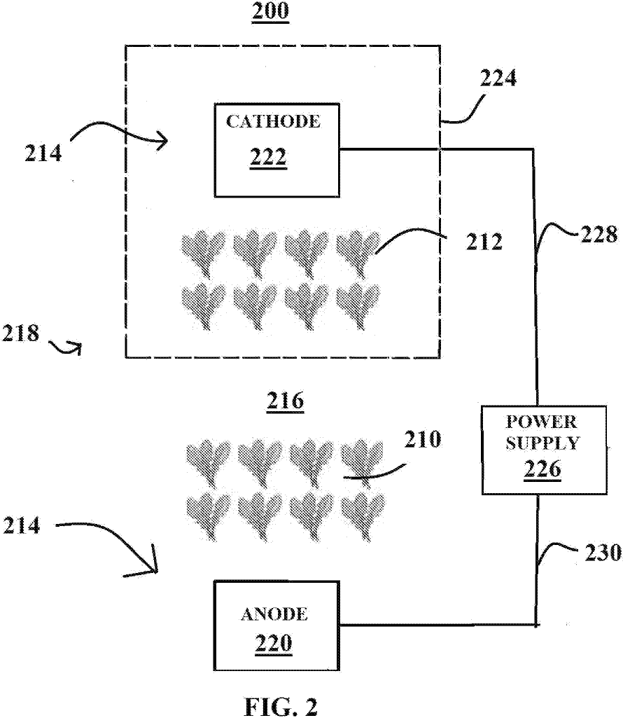

Referring now to FIG. 2 with continuing reference to the foregoing figure, another embodiment of a garden, generally designated by the numeral 200, is shown. Like the embodiment shown in FIG. 1, the garden 200 includes two groups of plants 210-212, an electrochemical treatment system 214, growth media 216, an electrochemical cell 218, an active alloy anode 220, a passive alloy cathode 222, and a cathode region 224.

Unlike the embodiment shown in FIG. 1, the electrochemical treatment system 214 includes a power supply 226 that can provide supplemental power to at least one of the active alloy anode 220 and the passive alloy cathode 222 to enhance the potential difference therebetween.

In this exemplary embodiment, the power supply 226 can be a DC power supply, such as a battery. The active alloy anode 220 and the passive alloy cathode 222 can connect to leads 228-230 extending from the power supply 226. The active alloy anode 220, the passive alloy cathode 222, and the power supply 226 can be arranged to generate a current which is substantially the maximum which can be economically achieved using the maximum allowable voltage which is allowed without special permits or processing to move transport ions within the growth media 216.

The geometric configuration of the electrochemical cell 218 is not critical. The active alloy anode 220 and the passive alloy cathode 222 can have any suitable geometric configuration. The active alloy anode 220, the passive alloy cathode 222, and the leads 228-230 can be in the form of wire, mesh, foil, an ingot, sheet or wire. The leads 228-230 can be flexible, semi-rigid, or rigid members.

It should be understood that in some embodiments the power supply 226 can be an AC power supply or a DC power supply connected to an AC power supply with a rectifier.

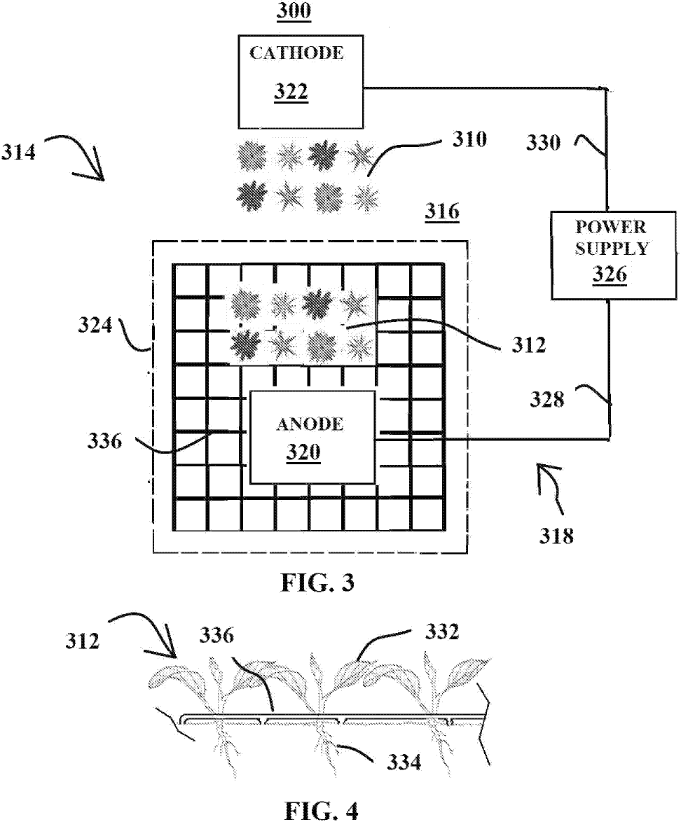

Referring now to FIGS. 3-4, there is shown another embodiment of a garden, generally designated by the numeral 300, which has a plurality of weeds that are separated into two groups 310-312 therein. The garden 300 includes an electrochemical treatment system 314 that is particularly adapted to treat growth media 316 that is positioned within the garden 300.

The system 314 is particularly adapted to inhibit and/or to control the growth of weed group 312 through the treatment of the growth media 316 with the ultimate goal of eliminating the weeds within the weed group 312. In this particular embodiment, the growth media 316 includes soil. The system 314 can be provided in an assembled form or as a kit for assembly.

As shown in FIG. 3, the system 314 is essentially an electrochemical cell 318 having an active alloy anode 320 and a passive alloy cathode 322. The immersion or submersion of the active alloy anode 320 and the passive alloy cathode 322, at least partially, creates the electrochemical cell 318 because the growth media 316 includes an aqueous solution that includes transport ions. The transport ions can be attracted to the passive alloy cathode 322, so that the growth of the weed group 312 can be controlled within an anode region 324.

The system 314 includes a power supply 326 that can provide additional power to at least one of the active alloy anode 320 and the passive alloy cathode 322 to enhance the potential difference therebetween. In this exemplary embodiment, the power supply 326 can be a DC power supply, such as a battery.

It should be understood that in some embodiments the power supply 326 can be an AC power supply or a DC power supply connected to an AC power supply with a rectifier.

The active alloy anode 320 and the passive alloy cathode 322 can connect to leads 328-330 extending from the power supply 326. The active alloy anode 320, the passive alloy cathode 322, and the power supply 326 can be arranged to generate a current which is substantially the maximum which can be economically achieved using the maximum allowable voltage which is allowed without special permits or processing to move transport ions within the growth media 316.

As shown in FIGS. 3-4, the anode region 324 is an area/volume that is in proximity of the active alloy anode 320. In some embodiments, the anode region 324 is in close proximity to the active alloy anode 320. As indicated in FIG. 4, the anode region 324 is relatively shallow in this exemplary embodiment because a weed 332, typically, has shallow roots 334.

Additionally, the active alloy anode 320 includes a mesh adapter 336 that is connected to the active alloy anode 320 both mechanically and electrically. The mesh adapter 336 distributes the electrochemical treatment throughout the anode region 324.

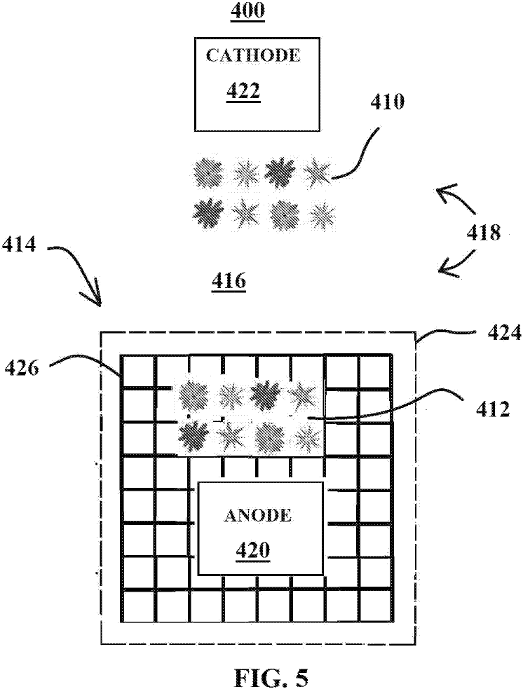

Referring now to FIG. 5 with continuing reference to the foregoing figures, another embodiment of a garden, generally designated by the numeral 400, is shown. Like the embodiments shown in FIGS. 3-4, the garden 400 includes two groups of weeds 410-412, an electrochemical treatment system 414, growth media 416, an electrochemical cell 418, an active alloy anode 420, a passive alloy cathode 422, and an anode region 424. The active alloy anode 420 includes a mesh adapter 426.

Unlike the embodiment shown in FIGS. 3-4, the system 414 does not include a power supply, such as the power supply 326 shown in FIG. 3, or leads, like the leads 328-330 shown in FIG. 3. As a result, the potential difference that is formed between the active alloy anode 420 and the passive alloy cathode 422 is based upon a galvanic current.

Like the embodiment shown in FIGS. 3-4, the geometric configuration of the electrochemical cell 418 is not critical. The active alloy anode 420 and the passive alloy cathode 422 can have any suitable geometric configuration. The active alloy anode 420 and the passive alloy cathode 422 can be in the form of wire, mesh, foil, an ingot, sheet or wire.

The system 314 shown in FIGS. 3-4 and the system 414 shown in FIG. 5 can be provided in an assembled form or as a kit for assembly to farmers, gardeners, and other people with interest in either home agriculture or industrial agriculture. The kits can be particularly adapted to third world environments, where external power is not readily available. As a result, the kits can provide an inexpensive means for improving plant growth.

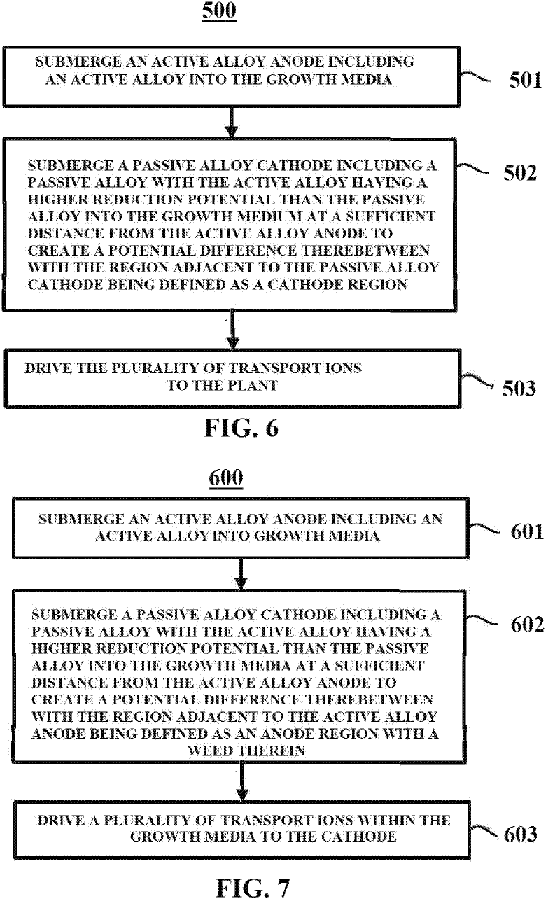

Referring now to FIG. 6 with continuing reference to the foregoing figures, an exemplary method, generally designated with the numeral 500, for enhancing plant growth within growth media is shown. The method 500 can be performed using the system 114 shown in FIG. 1 and/or the system 200 shown in FIG. 2.

The growth media includes an aqueous solution having a plurality of transport ions therein. In this exemplary embodiment, the growth media can be the growth media 116 shown in FIG. 1 and/or the growth media 216 shown in FIG. 2.

At 501, an active alloy anode including an active alloy is submerged into the growth media. In this exemplary embodiment, the active alloy anode can be the active alloy anode 120 shown in FIG. 1 and/or the active alloy anode 220 shown in FIG. 2.

At 502, a passive alloy cathode including a passive alloy with the active alloy having a higher reduction potential than the passive alloy is submerged into the growth media at a sufficient distance from the active alloy anode to create a potential difference therebetween with the region adjacent to the passive alloy cathode being defined as a cathode region. In this exemplary embodiment, the passive alloy cathode can be the passive alloy cathode 122 shown in FIG. 1 and/or the passive alloy cathode 224 shown in FIG. 2. The cathode region can be the cathode region 124 shown in FIG. 1 and/or the cathode region 224 shown in FIG. 2.

At 503, the plurality of transport ions is driven to the plant. In this exemplary embodiment, the plant can be a plant within plant group 112 shown in FIG. 1 and/or the plant group 212 shown in FIG. 2.

Referring now to FIG. 7 with continuing reference to the foregoing figures, an exemplary method, generally designated with the numeral 600, for controlling weed growth within growth media is shown. The method 600 can be performed using the system 314 shown in FIGS. 3-4 and/or the system 400 shown in FIG. 5. The method 600 can inhibit weed growth and/or kill weeds.

The growth media includes an aqueous solution having a plurality of transport ions therein. In this exemplary embodiment, the growth media can be the growth media 316 shown in FIGS. 3-4 and/or the growth media 416 shown in FIG. 5.

At 601, an active alloy anode including an active alloy is submerged into the growth media. In this exemplary embodiment, the active alloy anode can be the active alloy anode 320 shown in FIGS. 3-4 and/or the active alloy anode 420 shown in FIG. 5.

At 602, a passive alloy cathode including a passive alloy with the active alloy having a higher reduction potential than the passive alloy is submerged into the growth media at a sufficient distance from the active alloy anode to create a potential difference therebetween with the region adjacent to the active alloy anode being defined as an anode region with the weed therein. In this exemplary embodiment, the passive alloy cathode can be the passive alloy cathode 322 shown in FIGS. 3-4 and/or the passive alloy cathode 424 shown in FIG. 5. The anode region can be the anode region 324 shown in FIGS. 3-4 and/or the anode region 424 shown in FIG. 5.

At 603, the plurality of transport ions is driven to the passive alloy cathode. In this exemplary embodiment, the transport ions are driven from weeds within the weed group 312 shown in FIGS. 3-4 and/or the weeds within the weed group 412 shown in FIG. 5.

### Supported Features and Embodiments

The detailed description provided above in connection with the appended drawings explicitly describes and supports various features of apparatus and methods for enhancing the growth of plants through electrochemical treatment and for controlling the growth of weeds through electrochemical treatment.

Supported embodiments can provide various attendant and/or technical advantages in terms of a simple, low cost instrumentality to enhance plant growth using natural galvanic currents and/or impressed currents.

Other embodiments can provide various attendant and/or technical advantages in terms of a cost-effective system that can control, inhibit the growth, and/or kill weeds using electrochemistry. The system is not labor-intensive and does not require the use of toxic and/or dangerous herbicides. Additionally, the system can move ions within growth media to increase the pH and reduce moisture in regions that contain weeds.

Supported embodiments include a system that can move ions within a growth media to control the pH, the moisture level, and/or the flow of various nutrients to plants.

### Examples 1-27

In Examples 1-27, gardens were set up with various cathode-anode combinations for cucumber plants, avocado plants, and apple trees. The anodes included magnesium alloys, aluminum alloys, and zinc alloys. The cathodes included steel alloys, stainless steel alloys, and titanium alloys. Each anode was paired with each cathode for each plant, which resulted in twenty-seven combinations. The anode-cathode pairings resulted in galvanic currents.

Soil with electrolyte was used as a medium for the cucumber plants and the apple trees. A hydroponic aqueous solution that included nutrients was used as a medium for the avocado plants.

Plants were placed in both a cathode region and an anode region. The plants grew faster in the cathode region.

### Examples 28-33

In Examples 28-33, gardens were set up for squash plants having a magnesium alloy anode and a steel cathode. The medium included, primarily, sand with varying amounts of potting soil. The percentage of soil ranged from about 5% to about 2% to about 1%, which was present to provide nutrients.

In Examples 28-30, the magnesium alloy anode and the steel cathode formed a galvanic current. In Examples 31-33, the galvanic current was supplemented with an impressed current.

Squash plants were placed in both a cathode region and an anode region. The plants grew faster in the cathode region.

### Example 34

In Example 34, a garden was set up for tomato plants that included a magnesium alloy anode and a steel cathode. The medium included soil. Tomato plants were placed in both a cathode region and an anode region. The plants grew faster in the cathode region.

The tomatoes in the anode region were black due to a lack of calcium. The tomatoes in the cathode region were red because calcium ions in the soil were attracted to the cathode.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. An electrochemical treatment system for enhancing the growth of a plant within growth media,
wherein the growth media includes an aqueous solution having a plurality of transport ions therein, the electrochemical treatment system comprising:
an electrochemical cell,
the electrochemical cell having an active alloy anode including an active alloy and a passive alloy cathode including a passive alloy with the active alloy having a higher reduction potential than the passive alloy within the growth media,
wherein the active alloy anode and the passive alloy cathode are submerged in the growth media at least partially and are positioned at a sufficient distance to create a potential difference therebetween with the region adjacent to the passive alloy cathode being defined as a cathode region, and
wherein the plant is positioned within the cathode region and the potential difference is driving the plurality of transport ions to the plant.

2. The electrochemical treatment system of claim 1, wherein the growth media is growth media selected from the group consisting of soil, clay, and water.

3. The electrochemical treatment system of claim 1, wherein the active alloy is an alloy selected from the group consisting of a zinc alloy, a magnesium alloy, and an aluminum alloy.

4. The electrochemical treatment system of claim 2, wherein the active alloy is an alloy selected from the group consisting of a zinc alloy, a magnesium alloy, and an aluminum alloy.

5. The electrochemical treatment system of claim 1, wherein the passive alloy is an alloy selected from the group consisting of a titanium alloy, a steel alloy, a stainless steel alloy, and an iron alloy.

6. The electrochemical treatment system of claim 2, wherein the passive alloy is an alloy selected from the group consisting of a titanium alloy, a steel alloy, a stainless steel alloy, and an iron alloy.

7. The electrochemical treatment system of claim 3, wherein the passive alloy is an alloy selected from the group consisting of a titanium alloy, a steel alloy, a stainless steel alloy, and an iron alloy.

8. The electrochemical treatment system of claim 4, wherein the passive alloy is an alloy selected from the group consisting of a titanium alloy, a steel alloy, a stainless steel alloy, and an iron alloy.

9. The electrochemical treatment system of claim 1, further comprising:
an external power source connecting to the active alloy anode and the passive alloy cathode to enhance the potential difference therebetween.

10. An electrochemical treatment system for controlling the growth of a weed within growth media,
wherein the growth media includes an aqueous solution having a plurality of transport ions therein, the electrochemical treatment system comprising:
an electrochemical cell,
the electrochemical cell having an active alloy anode including an active alloy and a passive alloy cathode including a passive alloy with the active alloy having a higher reduction potential than the passive alloy within the growth media,
wherein the active alloy anode and the passive alloy cathode are submerged in the growth media at least partially and are positioned at a sufficient distance to create a potential difference therebetween with the region adjacent to the active alloy anode being defined as an anode region, and
wherein the weed is positioned within the anode region and the potential difference is driving the plurality of transport ions to the passive alloy cathode.

11. The electrochemical treatment system of claim 10, wherein the potential difference drives transport ions to the passive alloy cathode to reduce the amount of moisture within the anode region.

12. The electrochemical treatment system of claim 10, wherein the potential difference drives transport ions to the passive alloy cathode to increase the pH of the growth media within the anode region.

13. The electrochemical treatment system of claim 10, wherein the active alloy anode includes a mesh.

14. The electrochemical treatment system of claim 10, wherein the growth media is growth media selected from the group consisting of soil, clay, and water.

15. The electrochemical treatment system of claim 10, wherein the active alloy is an alloy selected from the group consisting of a zinc alloy, a magnesium alloy, and an aluminum alloy.

16. The electrochemical treatment system of claim 14, wherein the active alloy is an alloy selected from the group consisting of a zinc alloy, a magnesium alloy, and an aluminum alloy.

17. The electrochemical treatment system of claim 10, wherein the passive alloy is an alloy selected from the group consisting of a titanium alloy, a steel alloy, a stainless steel alloy, and an iron alloy.

18. The electrochemical treatment system of claim 14, wherein the passive alloy is an alloy selected from the group consisting of a titanium alloy, a steel alloy, a stainless steel alloy, and an iron alloy.

19. The electrochemical treatment system of claim 15, wherein the passive alloy is an alloy selected from the group consisting of a titanium alloy, a steel alloy, a stainless steel alloy, and an iron alloy.

20. The electrochemical treatment system of claim 10, further comprising:
an external power source connecting to the active alloy anode and the passive alloy cathode to enhance the potential difference therebetween.
